(19) United States
(12) Patent Application Publication
(10) Pub. No.: US 2016/0037588 A1
(43) Pub. Date: Feb. 4, 2016

(54) INDUCTION COOKER HOB AND WORKTOP ARRANGEMENT

(71) Applicant: ELECTROLUX APPLIANCES AKTIEBOLAG, Stockholm (SE)

(72) Inventors: Laurent Jeanneteau, Forli (IT); Thibaut Rigolle, Forli (IT); Alex Viroli, Forli (IT); Claudio Paolini, Forli (IT)

(21) Appl. No.: 14/769,985

(22) PCT Filed: Mar. 14, 2014
(86) PCT No.: PCT/EP2014/055118

§ 371 Date: Aug. 24, 2015

(30) Foreign Application Priority Data
Apr. 8, 2013 (EP) 13162649.1

(51) Int. Cl. H05B 6/12

(52) U.S. Cl. CPC H05B 6/1209; H05B 6/129

(57) ABSTRACT

An induction cooker hob which includes a cooking plate configured for placing cookware to be heated on an upper side thereof. At least one induction heating element is attached to an averted lower side of the cooking plate. The hob further includes a self-contained electronics housing accommodating therein essentially all electronic components required for operating and powering the at least one induction heating element.

The present invention in particular is directed to an induction cooker hob and a worktop arrangement comprising such an induction cooker hob.

Cooking hobs, known for example from DE 101 63 839 A1, in general comprise one or more heating elements, such as for example induction heating elements, and related electronics accommodated in a case usually made from sheet metal. Respective cooking hobs in many cases are adapted to be mounted on top of cooking ovens or other devices. However, the known designs, constructional arrangements and configurations in some cases are quite cumbersome and difficult to handle, and hence there is still room for improving handling and operation.

Therefore, it is an object of the invention to remove the disadvantages observed with the state of the art. In particular an induction cooking hob and corresponding worktop arrangement shall be provided which are suitable for improving handling and operability.

This object in particular is solved by the independent claims. Embodiments in particular result from the dependent claims.

According to claim 1 an induction cooker hob is provided, which comprises a cooking area, in turn comprising a cooking plate. The cooking plate is configured for placing cookware to be heated or intended to be heated on an upper side thereof.

The proposed induction cooker hob further comprises at least one heating element attached to a lower side of the cooking plate, averted from the upper side.

The cooking plate of the proposed induction cooker hob is adapted and configured to be switched, in particular moved or pivoted, between two, different, defined support positions, and is adapted to be securely positioned in either of the two support positions.

The term “defined” in particular shall mean that the induction cooker hob, in particular cooking plate, has provisions for securely supporting or retaining the cooking plate in either of the two, in particular at least two, support positions. Movement between the two support positions in particular is such that the cooking plate can be securely fixed or fixedly supported, in particular locked, in either of the two support positions.

The term “switch” in particular shall mean that the cooking plate can occupy and be transferred between the two support positions, in particular by carrying out a rotational and/or translational and/or swivelling movement or motion.

Switching the cooking plate between the two defined support positions is adjusted and customized such that in a working position the cooking plate is oriented or aligned essentially horizontally and in a rest position the cooking plate is oriented or aligned essentially vertically.

In the horizontal alignment, the cooking plate can be used in ordinary cooking mode. The vertical alignment is a type of stand-by position in which the cooking plate is parked in a space-saving manner. The cooking plate may be configured to be brought from the stand-by position into the active position, i.e working position, via a simple movement, such as in particular a swivelling and/or rotating movement.

The advantage of providing two defined support positions in particular is that the cooking plate can be arbitrarily and freely moved to the rest position in which the area occupied by the cooking plate in the working position can be used by the user as a working space. If a cooking operation is required, the cooking plate can be transferred to the working position or active position in a simple action, in particular swivelling and/or rotating action.

Note that in the working position, the cooking plate is oriented horizontally, i.e. essentially horizontally, in particular to allow cookware to be placed thereon for being heated. In the rest position, which may also be designated as an idle or inactive position, the cooking plate is oriented vertically, i.e. essentially vertically.

Note that the terms horizontally and vertically in particular shall correspond to situations in which the induction cooker, in particular the cooking plate is oriented in parallel and perpendicular to a worktop on which the induction cooking heater is placed. In general the worktop surface is oriented essentially horizontally and the direction perpendicular to the worktop surface is oriented essentially vertically.

Note, that the terms working position and rest position to a certain extent characterize the operational modes available in respective positions. Whilst in the working position, the induction cooker hob can be operated to heat cookware placed thereon, the rest position does not allow placing cookware thereon but rather provides a tidied-up and space saving configuration.

In embodiments, the induction cooker hob may further comprise a self-contained electronics housing or case. Self-contained in particular shall mean that the electronics housing or case is implemented as a separate or discrete component part of the induction cooker hob, but being suitable for being merged with the cooking plate or cooking area, in particular to establish a single constructional unit.

The electronics housing is and may be configured to accommodate therein essentially all or even all electronic components required for operating and powering the at least one induction heating element.

In particular, the electronics housing shall be adapted to accommodate therein at least the electronic components required for operating and powering the at least one induction heating element and the electronic components requiring active cooling, in particular in order to avoid over-temperature induced damages. Electronic components requiring no cooling and special treatment or housing can be arranged outside the electronics housing, which may be reflected by the term “essentially all” used beforehand.

Note that the electronics housing in particular may be adapted to accommodate respective electronic elements and to physically separate, in particular thermally separate, them from the induction heating elements, in particular induction coils. This may be advantageous with respect to service and lifetime.

The proposed configuration may lead to compact and space saving designs. In particular, the cooking area can be implemented in a compact and slim design or style. These facts may lead to enhanced operability and handling as compared to known devices.

In embodiments it is provided that the electronics housing is arranged adjacent to, in particular laterally adjacent to, next to or sideways, the cooking plate. This has the advantage, that the cooking plate as such can be realized in a comparatively slim, and in some instances space-saving design.

A slim and space-saving design in particular may be advantageous for pivotable embodiments, i.e. for embodiments in which the cooking plate is moveable or transferrable between the two support positions. In particular the electronics housing may have provisions or elements for mechanically fixing the cooking plate in either of the two support positions. Respective elements may be support legs and/or snap-fitting and/or shape fitting elements, in particular if the cooking plate is movable between the two support positions in a rotating movement.

In further embodiments, the electronics housing may be connected to the cooking plate to constitute a single constructional unit. This in particular shall mean that the cooking plate and electronics housing are combined or are adapted to be combined in such a way that the induction cooker can be handled and operated as a single device i.e. operational unit.

In embodiments, the electronics housing accommodates an air circulating fan. The air circulation fan may be configured to pass cooling air through the electronics housing for cooling the electronic components.

A respective air circulating fan may be an axial fan configured and adapted to pass air through at least the electronics housing.

The airflow generated by the fan may be constituted to cool electronics arranged within the electronics housing. Providing the fan within the electronics housing has the advantage of a comparatively compact and integrated design.

Note that the fan may be configured and designed to be able to provide cooling also to the at least one induction heating element, in particular induction coil.

In embodiments it may be provided that the electronics housing has an elongate shape, preferably with a circular, square or triangular cross section. Such shapes are advantageous for generating an efficient cooling airflow through the electronics housing. Besides this, electronics housings of the proposed designs are advantageous for being attached to the cooking plate, in particular along the short or long side of the cooking plate.

The proposed cross sections as proposed for the electronics housing may be favourable for placing and/or at least partially supporting the induction cooker hob in vertical and horizontal operational positions. In particular, the housing may have provisions for positioning and/or fixing and/or securing the cooking plate in either of the two support positions.

Further, with the proposed shape and geometries of the electronics housing it may be provided that the air circulating fan is adapted to generate a cooling air-flow in parallel to the axial direction through the electronics housing which in particular in this case acts as an air-flow channel. Here, the air circulating fan in particular may be an axial fan with a rotational axis of the fan blades being parallel, coinciding or being aligned with the longitudinal or axial direction of the electronics housing. The fan may be arranged at one longitudinal end of the electronics housing. Under these circumstances, effective cooling of the electronic components arranged within the electronics housing may be obtained.

In a variant, the electronics housing comprises a branch-off section configured to branch-off, in a direction transversely to the axial cooling air flow direction through the electronics housing, a portion of the cooling air-flow generated by the air circulating fan towards the at least one induction heating element.

In particular, the electronics housing may be used as a cooling air channel providing a primary air flow. From the cooling air channel one or several branches or air outlets may be provided in a direction transverse to the axial or longitudinal direction of the electronics housing. The branches and/or air outlets may be designed and configured to generate a secondary cooling air flow towards and past the at least one induction heating element.

The proposed cooling concept, ducting and routing of the air flow in particular permitted by the proposed housing allows, while providing efficient cooling, comparatively compact and slim designs, in particular of the cooking plate.

In embodiments, the cooking plate is suspended pivotably around a pivot axis, in particular horizontal pivot axis, such that at least the cooking plate is moveable between the working position and rest position in a pivoting movement. Here, movement actions for moving the induction cooker hob between the working position and rest position are comparatively user-friendly, uncomplicated and easy to carry out. In addition the proposed solution is comparatively robust and mechanically stable. The pivot axis may either run through or be related to the cooking plate itself or it may run through, be related to, and/or be defined by the housing. This in particular shall mean that the housing, in particular arranged along a long or short side of the cooking plate, may define a pivot or swivelling axis for transferring the cooking plate between the two support positions.

In embodiments, the induction cooker hob may be implemented as a stand-alone device. In this case, at least one of the lower side of the cooking plate and lower side of the electronics housing may comprise at least one support bracket. The support bracket is configured and adapted to support the induction cooker hob, at least partially, in particular the cooking plate and/or the electronics housing, on a work surface or support surface.

The at least one support bracket may be implemented to be able to support the induction cooker hob on the work surface in at least one of the working position and rest position. Preferably, separate support brackets are provided for the working position and rest position.

The work surface in particular may be a worktop in a kitchen, i.e. a kitchen top, in particular a part thereof.

The support bracket may for example be or comprise a leg or foot, or respective sections, configured to at least partially support the induction cooker hob, the cooking plate and/or the electronics housing on a work or support surface.

In other embodiments, the induction cooker hob is not implemented as a stand-alone device, but rather implemented as a built-in device. In this case, the induction cooker hob, in particular the electronics casing, may be attached, mounted or installed to a worktop of a kitchen top. In particular, the electronics housing may be used to, in particular rotatably and/or swivellably, fix the induction cooker hob to the worktop. In case of a pivotable configuration, the induction cooker hob, preferably the electronics housing or casing, may be attached pivotably to the worktop.

In embodiments, the induction cooker hob comprises a user interface configured for receiving user instructions for operating the at least one induction heating element.

The user interface may be implemented at, in or on at least one of the cooking plate and electronics housing.

The user interface may be configured such that it is automatically switched to the activated state in case that the induction cooking hob is transferred to the working position, and that it is automatically switched to the deactivated state in case that the induction cooking hob is transferred to the rest position.

Further it may be provided that the induction heating elements are automatically switched to the inactivated state, i.e. switched or powered off, in the rest position.

In case that the induction cooker hob can be moved between the working position and the rest position, a drive motor or actuator may be provided which is configured for moving the induction cooking hob, in particular the cooking plate, from the working position to the rest position and vice versa. The drive motor or actuator may be operated from the user interface, in particular via a specific switching element.

As can be seen, the proposed induction cooker hob is effective in reducing space requirement while still providing easy use and handling.

According to claim 10, a worktop arrangement or configuration is provided which comprises a worktop and an induction cooker hob as set out above. The worktop may be part of or constitute a part of a kitchen top. As to advantages and advantageous effects, reference is made to the description above. As proposed in claim 10, the cooking plate in the working position is positioned on and in parallel to the worktop and in the rest position it

In embodiments of the worktop arrangement it may be provided that the induction cooker hob is attached to the worktop so as to be moveable between a working position in which the cooking plate is positioned in the ordinary operational position parallel to the worktop surface and a rest position in which the cooking plate is oriented essentially perpendicular to the worktop surface, i.e. oriented vertically upwards.

In particular, the induction cooker hob may be switched from the working position to the rest position in which the worktop area occupied by the cooking plate in the working position is free and can be used as an ordinary worktop surface. As to further advantages, reference is made to the description above and further below.

In further embodiments of the worktop arrangement, the induction cooker hob is pivotably supported on, at or within the worktop so as to be moveable between the working position and rest position in a pivoting movement. Implementing the transfer from the working position to the rest position via a pivoting movement is advantageous, in particular for easy handling and operation. As to advantages, reference is made also to the description above and further below.

Selected embodiments or examples of the invention shall now be described in connection with the annexed figures in which:

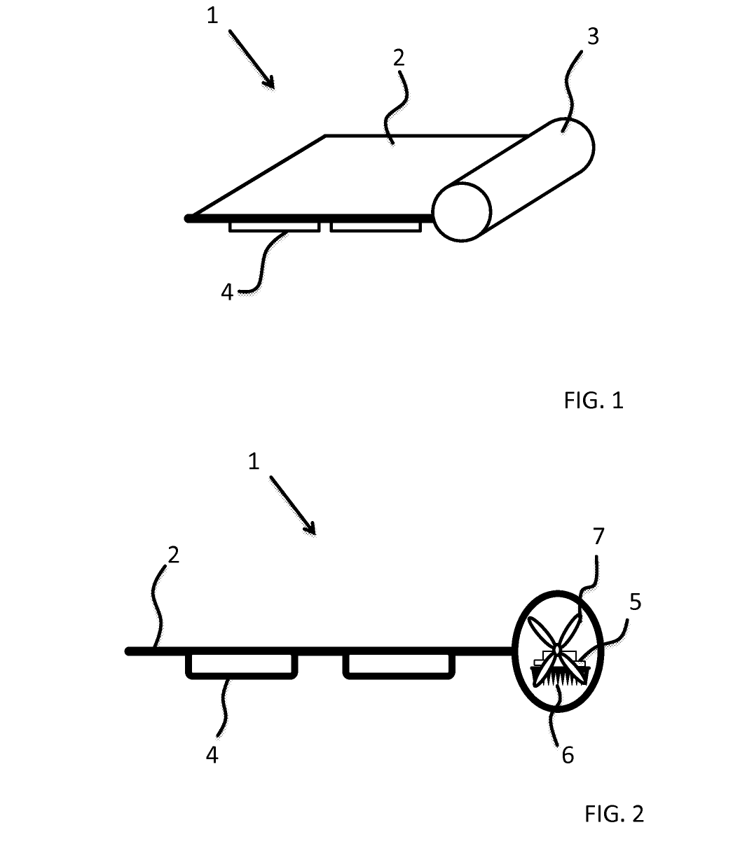

FIG. 1 shows a schematic perspective view of an induction cooker hob;

FIG. 2 shows a schematic side view of the induction cooker hob;

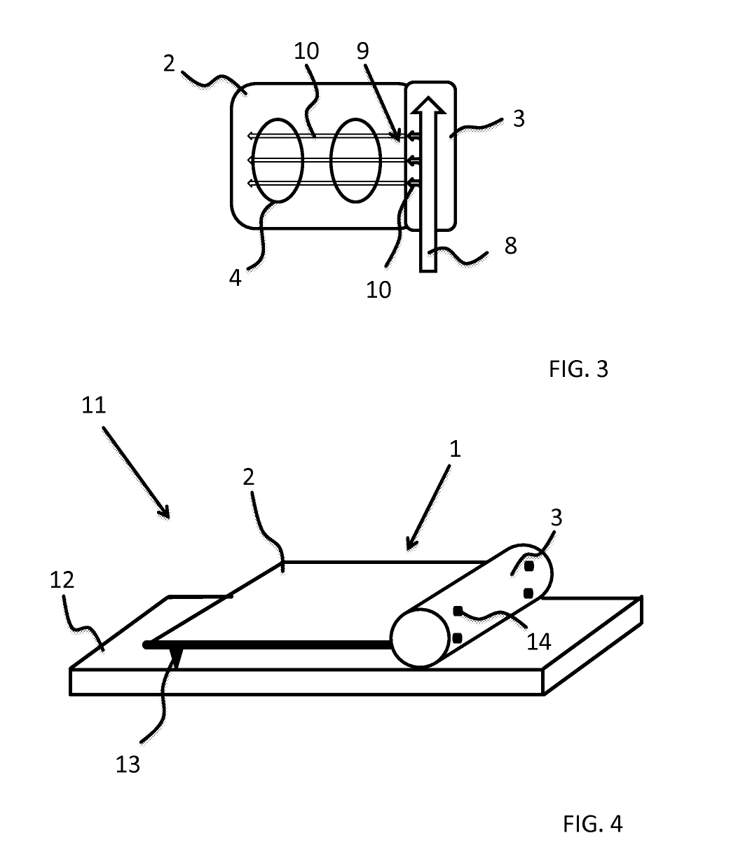

FIG. 3 shows a top view of the induction cooker hob;

FIG. 4 shows a first variant of a worktop arrangement;

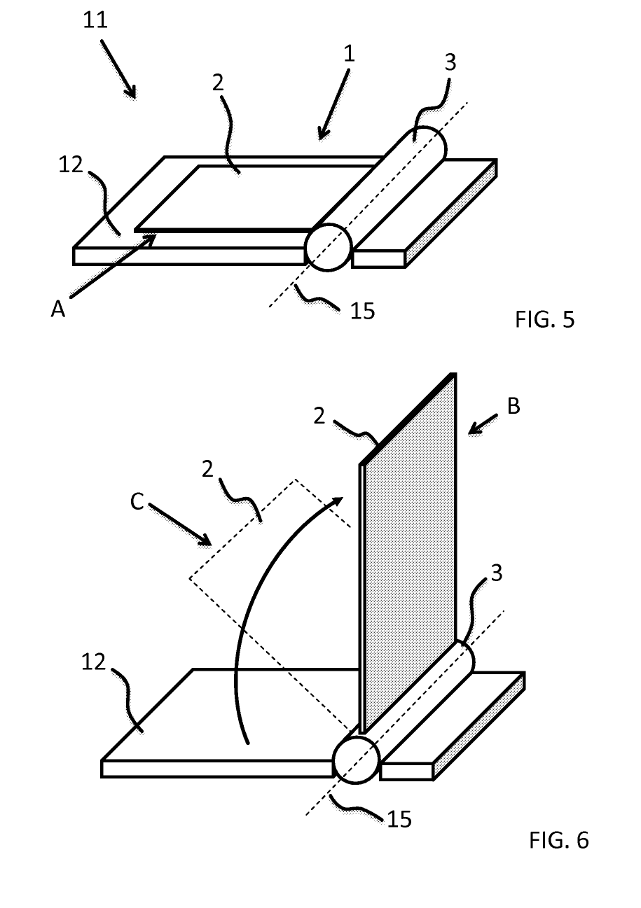

FIG. 5 shows a second variant of a worktop arrangement; and

FIG. 6 shows the worktop arrangement of FIG. 5 in different operational positions.

FIG. 1 shows a schematic perspective view of an induction cooker hob 1. The induction cooker hob 1 comprises a cooking plate 2 and a self-contained electronics housing 3.

The cooking plate 2 in the present case comprises two induction heating elements 4 attached to the lower side of the cooking plate 2, which in the present case is a glass plate.

Note that the induction cooker hob 1 may comprise any suitable number of induction heating elements 4, in particular induction coils. Further it shall be mentioned, that the induction heating elements, in particular induction coils may be of any suitable shape, in particular they may be implemented as circular coils, half-circular or half-disc coils or square coils.

In the electronics housing 3 there are provided electronic components required for operating and powering the induction heating elements 4. It is preferred, that the electronics housing 3 accommodates essentially all the electronics required for operating and powering the induction heating elements 4.

The electronics housing 3 may be arranged at and attached to and along a short side of the cooking plate 2 as indicated in the figures. However, the electronics housing may also be provided at a long side of the cooking plate 2. The arrangement and mutual attachment of electronics housing 3 and cooking plate 2 may lead to a favourable construction in which the cooking plate 2 and electronics housing 3 constitute a single handleable unit. The proposed construction in particular enables compact and slim designs in turn allowing space saving arrangements.

As can be seen in particular from FIG. 1, the electronics housing 3 is implemented in an elongate cylindrical shape running along the short side of the cooking plate 2. It shall be noted, that the electronics housing 3 may be implemented in other ways and/or of other suitable shapes, in particular as set out further above. As already mentioned, the electronics housing 3 may be provided or implemented along a long-side of the cooking plate 2, in which case a pivot axis for switching the cooking plate 2 between the two support positions may be oriented in parallel to the long-side.

FIG. 2 shows a schematic side view of the induction cooker hob 1. From FIG. 2 it can be seen, that the electronics housing 3 accommodates electronic components 5 together with a heatsink 6. As can also be seen from FIG. 2, the induction heating elements 4 are attached essentially as sole additional elements to the lower side of the cooking plate 2, which allows a comparatively slim design. Note that the induction heating elements 4 may be covered by a lower cover element adapted to shield the induction heating elements 4 from outer impacts and to avoid direct access to the induction heating elements 4.

In the present case, the electronics housing 3 further accommodates an air circulating fan 7 adapted to generate a cooling airflow through the electronics housing 3 past the electronic components 5 and heatsink 6.

The fan 7 in the present case is an axial fan which is adapted to generate an axial airflow through the electronics housing 3. The electronics housing 3 hence acts as an air flow channel.

Details of the fan driven air flow can be seen in more detail in FIG. 3 which shows a top view of the induction cooker hob 1. The fan 7 is arranged in the electronics housing 3 and is configured to generate a primary airflow 8 in axial direction through the electronics housing 3.

The electronics housing 3 and the cooking plate 2 are designed and configured, for example by providing a branch-off section 9, such that a secondary airflow 10 can and will be generated.

The secondary airflow 10 is configured to pass through or by the induction heating elements 4 for cooling them. The proposed cooling arrangement allows comparative compact designs while securing sufficient cooling.

FIG. 4 shows a first variant of a worktop arrangement 11 in accordance with the invention. The worktop arrangement 11 comprises a worktop 12 which may be a kitchen top. The worktop arrangement 11 further comprises an induction cooker hob 1.

The induction cooker hob 1 in the present case is implemented as a stand-alone device. Therefore, the induction cooker hob 1 comprises at a lower side of the cooking plate 2 at least one support bracket 13 which is configured such that the induction cooker hob 1 can be placed in level on the worktop 12.

In the present case, the lower side of the electronics housing 3 acts as a further rest for placing the induction cooker hob 1 in level on the worktop 12. However, if required, the electronics housing 3 may also comprise support brackets or legs.

As an option, further support legs 14 may be provided on or at the electronics housing 3 on a side averted from the cooking plate 2. These further support legs 14 may be implemented and configured such that the induction cooker hob 1 may be positioned in a vertical arrangement, in which the cooking plate 2 is oriented vertically upwards. Here, a space saving placement or storage of the induction cooker hob 1 is possible. However, it shall be noted that providing the further support legs 14 is just an optional variant of the stand-alone version.

FIG. 5 shows a second variant of a worktop arrangement 11. The difference to the worktop arrangement 11 in FIG. 4 is that the induction cooker hob 1 in FIG. 6 is integrated in the worktop 12. In more detail, the electronics housing 3 is partially inserted into a cutout or gap provided in the cooktop 12.

The overall arrangement is such that the cooking plate 2 can be positioned in level and evenly on the upper surface of the worktop 12. The position, in which the induction cooker hob 1, in particular cooking plate 2 is positioned in parallel, in level and evenly on the worktop 12 can be designated working position A of the induction cooker hob 1. In the working position A, the induction cooker hob 1 can be used as an ordinary hob for heating cookware and the like.

FIG. 6 shows the worktop arrangement 11 of FIG. 5 in different operational positions. As can be deduced from FIG. 6, the induction cooker hob 1 of the second variant is suspended or mounted to the worktop 12 to be pivotable around a pivot axis 15 running parallel to the surface of the worktop 12, in the present case essentially horizontally.

This means that the induction cooker hob 1, in particular the cooking plate 2, can be moved between the support positions A and B, in particular from the working position A as shown in FIG. 5, via a pivoting movement indicated by an arrow in FIG. 6, to a rest position B.

In the rest position B, the induction cooker hob 1 is oriented vertically, in more detail, the cooking plate 2 is oriented vertically upwards. In the rest position B, the induction cooker hob 1 is arranged in a space saving arrangement and the worktop surface occupied by the cooking plate 2 in the working position A can be used as an ordinary worktop for preparing food, placing items and the like.

The pivoting movement available for the induction cooker hob 1, in particular cooking plate 2, is indicated in FIG. 6 via a bent arrow. For a better understanding an intermediate position C drawn in dashed lines shall illustrate the rotating or pivoting movement of the induction cooker hob 1.

It shall be mentioned, that a user interface (not explicitly shown) for operating and adjusting operation of the induction cooker hob 1 may be provided on or at the electronics housing 3 and/or on or at the cooking plate 2.

In all, it becomes clear that the induction cooking hob as proposed herein is effective in providing space saving arrangements and easy handling and operation.

### LIST OF REFERENCE NUMERALS

1 induction cooking hob
2 cooking plate
3 electronics housing
4 induction heating element
5 electronic components
6 heatsink
7 air circulating fan
8 primary airflow
9 branch-off section
10 secondary airflow
11 worktop arrangement
12 worktop
13 support bracket
14 further support legs
15 pivot axis
A working position
B rest position
C intermediate position

What is claimed is:

1. Induction cooker hob (1) comprising a cooking plate (2) configured for placing cookware to be heated on an upper side thereof, and at least one induction heating element (4) attached to an averted lower side of the cooking plate (2), wherein the cooking plate (2) can be switched between two defined support positions (A, B), and is adapted to be securely positioned in either of the two support positions such that in a working position (A) the cooking plate is oriented essentially horizontally and in a rest position (B) the cooking plate is oriented essentially vertically,

2. Induction cooker hob according to claim 1, further comprising a self-contained electronics housing (3) accommodating therein essentially all electronic components (5, 6, 7) required for operating and powering the at least one induction heating element (4).

3. Induction cooker hob according to claim 2, wherein the electronics housing (3) is arranged adjacent to, in particular laterally adjacent to the cooking pate (2), and connected to the cooking plate (2) to constitute a single constructional unit.

4. Induction cooker hob (1) according to claim 2, wherein the electronics housing (3) accommodates an air circulating fan (7) configured to pass cooling air (8) through the electronics housing (3) for cooling the electronic components (5, 6).

5. Induction cooker hob (1) according to at least one of claims 2, wherein the electronics housing (3) has an elongate shape, preferably with a circular, square or triangular cross section, and wherein the air circulating fan (7) preferentially is adapted to generate a cooling air-flow (8) in parallel to the axial direction through the electronics housing (3) acting as an air-flow channel.

6. Induction cooker hob (1) according to claim 5, wherein the electronics housing (3) comprises a branch-off section (9) configured to branch-off transversely to the axial cooling air flow direction a portion (9) of the cooling air-flow (8) generated by the air circulating fan (7) towards the at least one induction heating element (4).

7. Induction cooker hob (1) according to at least one of claims 1 to 6 claim 1, wherein the cooking plate (2) is suspended pivotably around a pivot axis (15), in particular horizontal pivot axis, such that at least the cooking plate (2) is moveable between the working position (A) and rest position (B) in a pivoting movement.

8. Induction cooker hob (1) according to claim 1, being implemented as a stand-alone device, wherein at least one of the lower side of the cooking plate (2) and, if dependent on claim 2 the lower side of the electronics housing (3), comprises at least one support bracket (13, 14) configured for supporting the induction cooker hob (1) on a work surface (12) in at least one of the working position (A) and rest position (B).

9. Induction cooker hob (1) according to claim 1, further comprising a user interface configured for receiving user instructions for operating the at least one induction heating element (4), wherein the user interface is implemented at, in or on at least one of the cooking plate (2) and electronics housing (3).

10. Worktop arrangement (11) comprising a worktop (12) and an induction cooker hob (1) according to claim 1, wherein the cooking plate (2) in the working position (A) is positioned on the worktop (12) and in the rest position (B) may be is placed vertical to the worktop (12).

11. Worktop arrangement (11) according to claim 10, wherein the induction cooker hob (1) is attached to the worktop (12) so as to be moveable between a working position (A) in which the cooking plate (2) is positioned in the ordinary operational position parallel to the worktop surface and a rest position (B) in which the cooking plate (2) is oriented essentially perpendicular to the worktop surface.

12. Worktop arrangement (11) according to claim 10, wherein the induction cooker hob (1) is pivotably supported on, at or within the worktop (12) so as to be moveable between the working position (A) and rest position (B) in a pivoting movement.
